(19) United States
(12) Patent Application Publication
(10) Pub. No.: US 2017/0103430 A1
(43) Pub. Date: Apr. 13, 2017

(54) RESPONSIVE ADVERTISEMENT FORMATS BASED ON VIEWABILITY PIXEL DATA

(71) Applicant: Conversant LLC, Chicago, IL (US)

(72) Inventor: Jeffrey Gilbert, Chicago, IL (US)

(21) Appl. No.: 15/288,992

(22) Filed: Oct. 7, 2016

Related U.S. Application Data
(60) Provisional application No. 62/238,571, filed on Oct. 7, 2015.

(51) Int. Cl. G06Q 30/02; G06F 17/21

(52) U.S. Cl. CPC G06Q 30/0277; G06F 17/211; G06T 2210/12; G06T 3/40

(57) ABSTRACT

A technique is presented for determining coordinates of a region within a web page or other window is viewable to a user. A minimum bounding rectangle is defined for the viewable area of a viewport into the web page or other window, by defining one corner at (min(X), min(Y)) and a second corner at (max(X), max(Y)). Information about the minimum bounding rectangle may be presented to the advertisement. The advertisement may then reformat itself, such as by resizing the advertisement or by rearranging the contents of the advertisement to ensure important areas are inside the minimum bounding rectangle.

### TECHNICAL FIELD

The present invention relates to the field of web-based displays, and in particular to a technique for resizing an online advertisement to be more viewable based on viewability of pixel data.

### BACKGROUND ART

Increasingly, publishers of online content depend upon advertising content to provide revenue to support their websites. Advertising based revenue models have been adopted by a large number of internet services. In selling advertisement space on a website, a decision has to be made as to the price that that space will cost. Today, advertising space is often sold on a pay-per-impression basis.

In pay-per-impression advertising, a charge is levied every time the web page containing the advertisement is viewed. Every time a web page containing the advertisement is downloaded to a user a charge is levied against the advertiser, who pays according to the volume of downloads (impressions) that have occurred.

A problem with current pay-per-impression techniques is that they do not accurately reflect whether the user viewed the advertisement. Because users may have different screen sizes, and open browser windows of different sizes on their display screens, an advertisement of a predetermined size and placed at a predetermined location on a web page may not always be completely visible in the browser window. The advertisement may be on a part of the web page that is not viewable in the user's browser window, or even though part of the advertisement was visible, an important part of the advertisement, such as the call to action, may not have been visible. This creates uncertainty as to the value of the advertisement to the advertiser, and thereby suppresses demand for internet advertising.

Accordingly, it would be desirable to develop an approach which more accurately reflects the number of times a particular advertisement has been viewed, better than merely counting the number of downloads, because the visibility of the advertisement is not ensured simply because the host web page has been downloaded.

One approach has been to monitor the area of the web page shown by a particular user's browser at a given moment. By knowing the dimensions of the browser's viewport and the position of the advertisement in the web page, whether the advertisement is in view (that is, within the browser's viewport) can be determined by observing the scroll position of the browser window (i.e. its vertical and horizontal position on the web page). Alternately or additionally, the position of the mouse cursor on the web page can be sensed. But these approaches have limited utility, because of restrictions on the information that parties within the process are able to derive.

Advertisements are often contained within (possibly nested) iframes in a host web page. An iframe provides a region within a web page in which other web content may appear. One important benefit for a publisher is protection of the web page. The publisher of a host web page typically has little or no control over the contents served in an advertisement. Content in iframes served from a different domain than that of the host web page cannot affect content in the host web page or even discover information regarding that page. This ensures the advertisement cannot corrupt the main content of the host web page. Therefore, publishers typically put advertisements into iframes.

However, that benefit to the publisher is a problem for the advertiser. Because content within the iframe cannot interact with the host web page, client-side code served with the advertisement cannot discover, for example, the dimensions (height and width) of the host web page, or where the browser viewport is in relation to the host web page, making the client-side code incapable of determining whether the advertisement is in view. Therefore, techniques that attempt to infer whether an advertisement is viewable by comparing the location of the browser viewport relative to the host web page fail in an iframe environment.

Some have attempted to resize the browser window to allow the advertisement to fit, but resizing the browser window may not always be feasible, or sufficient to display all of the advertisement. A way of determining whether a portion of an advertisement is outside of the current viewport, even in a sandboxed iframe, would be useful and allow web page designers and others to better tailor advertisements for visibility, such as be resizing the advertisement. Knowing whether and how much of the advertisement is visible on a user's screen may change the value of the advertisement for the advertiser, as well as affect the payment made to the web page owner. Being able to modify an advertisement to fit onto the user's visible screen could also improve the value of the advertisement and the payment. Therefore, a better way of knowing the viewability of an advertisement and allowing reformatting of the advertisement based on the viewability pixel data would be useful.

### BRIEF DESCRIPTION OF DRAWINGS

The accompanying drawings, which are incorporated in and constitute a part of this specification, illustrate an implementation of apparatus and methods consistent with the present invention and, together with the detailed description, serve to explain advantages and principles consistent with the invention. In the drawings,

FIG. 1 is a block diagram illustrating an advertisement rendered as part of a web page according to one embodiment.

FIG. 2 is a sequence of simulated screenshots illustrating issues related to placement of advertisements in a browser window.

FIG. 3 is a graph illustrating coordinates of a bounding box for advertisement according to one embodiment.

FIG. 4 is a flowchart illustrating a technique for determining viewability of a advertisement according to one embodiment.

FIG. 5 is a block diagram illustrating a system for generating and using responsive advertisements based on viewability according to one embodiment.

FIG. 6 is a block diagram illustrating a programmable device for calculating viewability of an advertisement according to one embodiment.

FIG. 7 is a swim lane chart illustrating operation of a system for use of responsive advertisements according to one embodiment.

### DESCRIPTION OF EMBODIMENTS

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts are understood to reference all instance of subscripts corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

Although some of the following description is written in terms that relate to software or firmware, embodiments can implement the features and functionality described herein in software, firmware, or hardware as desired, including any combination of software, firmware, and hardware. References to daemons, drivers, engines, modules, or routines should not be considered as suggesting a limitation of the embodiment to any type of implementation.

The terms “a,” “an,” and “the” are not intended to refer to a singular entity unless explicitly so defined, but include the general class of which a specific example may be used for illustration. The use of the terms “a” or “an” may therefore mean any number that is at least one, including “one,” “one or more,” “at least one,” and “one or more than one.”

The term “or” means any of the alternatives and any combination of the alternatives, including all of the alternatives, unless the alternatives are explicitly indicated as mutually exclusive.

The phrase “at least one of” when combined with a list of items, means a single item from the list or any combination of items in the list. The phrase does not require all of the listed items unless explicitly so defined.

As used herein, the term “a computer system” or a “programmable device” can refer to a single computer or programmable device or a plurality of computers or programmable devices working together to perform the function described as being performed on or by a computer system or programmable device.

As used herein, the term “processing element” can refer to a single hardware processing element or a plurality of hardware processing elements that together may be programmed to perform the indicated actions. The hardware processing elements may be implemented as virtual hardware processing elements of a virtual programmable device hosted on a physical hardware device. Instructions that when executed program the processing element to perform an action may program any or all of the processing elements to perform the indicated action. Where the processing element is one or more multi-core processors, instructions that when executed program the processing element to perform an action may program any or all of the multiple cores to perform the indicated action.

As used herein, the term “medium” can refer to a single physical medium or a plurality of media that together store the information described as being stored on the medium.

As used herein, the term “memory” can refer to a single memory device or a plurality of memory devices that together store the information described as being stored on the medium. The memory may be any type of storage device, including random access memory, read-only memory, optical and electromechanical disk drives, etc.

As used herein, the terms “visibility” and “viewability” (in any grammatical form) are to be considered synonymous, with both indicating whether the advertisement or other display element can be seen by the user.

Embodiments may be implemented in one or a combination of hardware, firmware, and software. Embodiments may also be implemented as instructions stored on a computer-readable storage medium, which may be read and executed by at least one processing element to perform the operations described herein. A computer-readable storage medium may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media.

Although described herein in terms of an online advertisement, online advertising is only one usage of the disclosed technique, and the scope of the invention is not limited to online advertising, but extends to any usage of display elements where the viewability of the display element may be of interest.

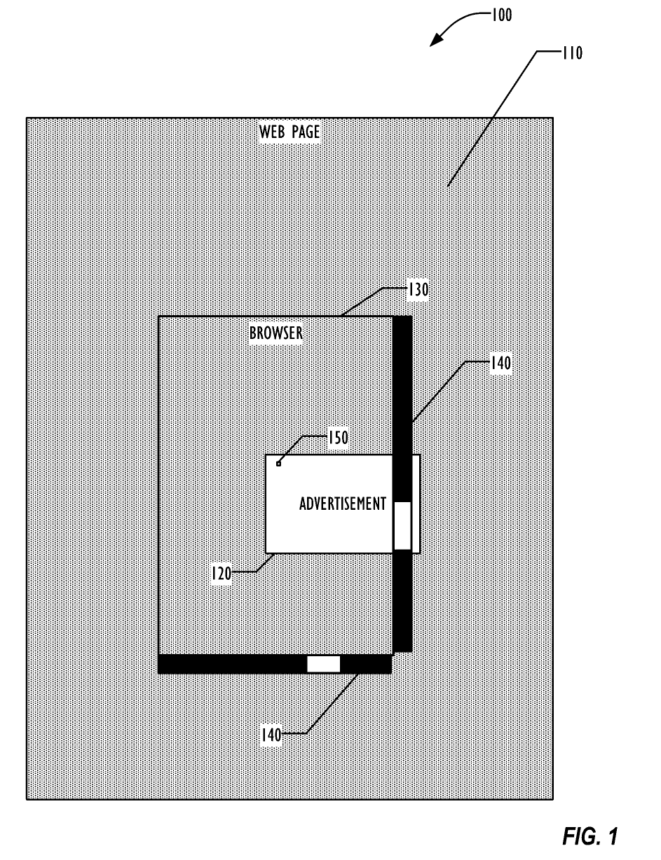

FIG. 1 is a block diagram illustrating a web page 100 according to one embodiment. The web page comprises a main area 110 in which content is displayed. The web page further comprises an advertisement 120. In this example, the advertisement 120 is contained within an iframe.

In alternative embodiments, other restricted or sandboxed environments than iframes could be used, for example a frame; a Microsoft Web Sandbox; or an SVG document. These other restricted environments are illustrative and by way of example only; other restricted environments may be used. Alternatively or in addition to sandboxing the client-side monitoring code may be restricted to a limited subset of available features, such as ECMAScript 5 strict mode.

FIG. 1 also illustrates a browser window 130. Only elements of the web page 100 which appear within a viewable portion of the browser window 130 (the viewport) are viewable to a user at a particular time. These elements of the web page 100 are said to be in view or visible. Elements which are not contained within a viewable portion of the browser window 110 are said to be not in view or not visible. In the example illustrated in FIG. 1, a portion of the advertisement 120 is visible and a portion of the advertisement 120 is not visible.

A user accessing the web page 100 will be able to move the browser window 130 around the web page 100 to view different elements of the page 100. The position of the browser window is typically indicated by scroll bars 140. The user may also be able to zoom in or zoom out of the host web page 100, a process which effectively changes the size of the browser window 130 relative to the web page 100. As a result of this, certain elements of the web page 100 may be in view at some times and not in view at others.

The size, scroll, and zoom of the browser window 130 determines whether and how much of the advertisement 120 is in view, which is of interest to the advertiser producing the advertisement 120 when deciding its value. Knowledge of the position of the scroll bars 140 can provide that information, if the position of the advertisement 120 on the web page 100 is known. However, in most cases, the advertisement is contained within an iframe on an external domain, and therefore the position of the scroll bars cannot be discovered by elements provided with the advertisement 120, because iframes are specified to isolate the web page 100 from content contained within the iframe.

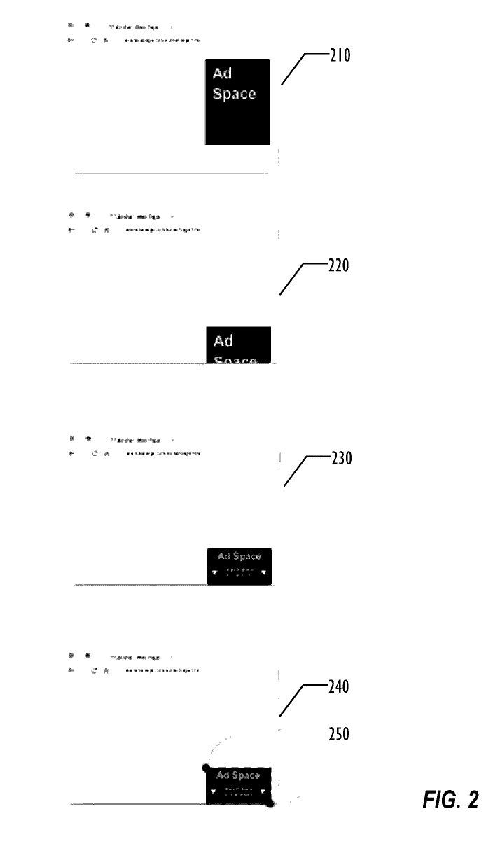

Any advertisement that can be placed on a web page is subject to the viewability concerns, and advertisements can be constructed so that they can be adjusted if viewability information were available. For example, current advertisements, illustrated in FIG. 2 in simulated screenshot 210, are built around the ideas of both placement and viewability to deliver advertisements that are actually seen by users. These mechanisms fail when an advertisement is partially out of view as illustrated in simulated screenshot 220, creating a need for “percentage in view” rules that burden the advertisement community. Ads that are not visible or are only partially visible may not qualify as an impression under these percentage in view rules. For example, according to Media Rating Council and the Interactive Advertising Bureau guidelines, a viewable impression requires 50% of an advertisements pixels to be visible. Modern advertisements would be able to respond to the space they had available to them, maximizing the opportunity for an advertisement to be viewed or created as an in view impression, if they had the necessary information on what would be visible. For example, the advertisement might be resized, as illustrated in simulated screenshot 230, to ensure that the advertisement fits within the available space on the user's screen.

Returning to FIG. 1, a test feature 150 is provided within the advertisement 120. The test feature 150 is provided through the iframe containing the advertisement 120. The test feature 150 may be implemented as a test pixel. For example, the test feature 150 may be a single, transparent test pixel overlaid on the advertisement 120. Other types of test features may be used, preferably implemented in a way that they would not be seen by the user viewing the web page in the browser viewport 130. In this way, the test feature 150 provides minimal intrusion into the functionality of the advertisement 120. In practice, multiple test features 150 may be used. In some embodiments, test features 150 may also be provided in the iframe outside of the advertisement 120, including test features 150 that may be outside of the current viewport 130. Whether these test features are viewable can be detected using any known technique for determining whether a single pixel or other test feature is viewable in the viewport.

By using measurement points in an advertisement, information can be obtained that allow resizing or reformatting of the advertisement to provide an advertisement that can be fully seen in the available space, or at least seen as much as possible.

As illustrated in simulated screenshot 240, using multiple “in view” indicators placed around an (x, y) or (x,y,z) position, we can confirm the viewable boundaries of the advertisement 120. Using in versus out states to confirm a single point, the technique described below can define a bounding box, for example using top left and bottom right to define the bounding box. This information can be transferred to the advertisement 120 via resizing the advertisement 120's container or by sending the information to the advertisement 120 itself without requiring access to the parent web page.

In some scenarios, while the advertisement 120 may remain at a size and placement that is not fully viewable, the techniques described herein allow maximizing the impact of the advertisement 120 by resizing the contents of the advertisement 120 to fill the bounding box area known to be in view. Even though parts of the advertisement 120 may remain unviewable (off the screen or hidden by another advertisement or window), the content of most importance may be made viewable. Thus, for example, the advertisement 120 may be considered 100% viewable—even though only 10% is in view—if the content messaging is capable of being reformatted to fit in the 10% that is viewable. Thus, finding the viewable area may make the advertisement inventory much more valuable and maximizing opportunities for advertisements to be delivered that otherwise would not count as billable inventory.

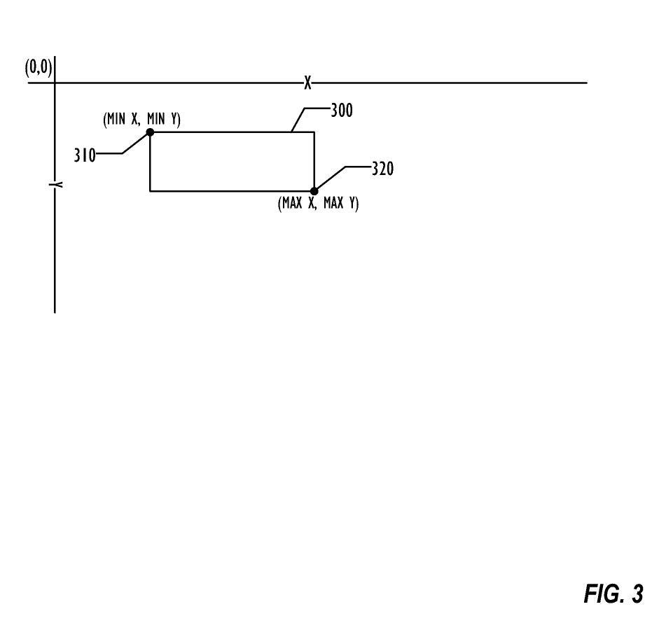

In one embodiment, illustrated in FIG. 3, a minimum bounding rectangle 300, sometimes known as a bounding box, may be defined as an expression of the maximum extents of the 2-dimensional advertisement 120 in a 2-dimensional coordinate system, defining a min(x), max(x), min(y), and max(y). With those coordinates, the minimum bounding rectangle 300 for the area visible in the viewport 130 can be defined, allowing the advertisement 120 or its contents to be reformatted to fit within the viewport 130.

As illustrated in FIG. 3, with those coordinates, the minimum bounding rectangle 300 may be defined, with corner 310 having the coordinates (min(x), min(y)) and corner 320 having the coordinates (max(x), max(y)), where the origin by convention is at the top left. (Other origin conventions may be used.) The X-Y coordinates of only two corners 310 and 320 of the rectangle 300 are sufficient to determine the rectangle 300, resulting in the fastest possible determination with the least amount of computational effort.

Any available technique for obtaining coordinate information may be used. How the coordinate information is collected may vary depending on the system in which the operation is performed. For example, a mobile device may have different techniques for reporting coordinate points than a native desktop application, and similarly a web page may have different techniques for gathering the information that would place an advertisement in an unfriendly sandboxed frame. But regardless of the technique for determining the coordinates of the two points, the rectangle 300 may be defined. In one implementation, the coordinates of test feature points 150 that are inside the viewport 130 and the coordinates of test feature points 150 that are outside the viewport 130 are used to determine the two corners of the bounding box. Any known technique for instrumenting the advertisement to select the measurement test features 150 and obtain their coordinate information may be used. In some implementations, coordinates of test feature points 150 randomly placed around the advertisement 120 may be used to determine the bounding box corners. In other implementations, points may be selected at predetermined locations in the advertisement 120 using any desired technique for selecting the measure points for the test features 150, such as defining an array of test features 150 across the advertisement 120.

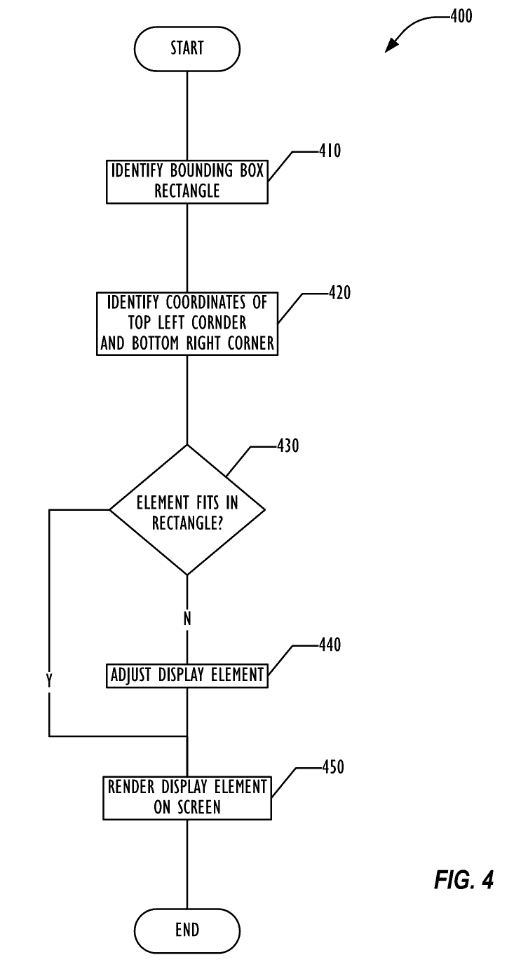

FIG. 4 is a flowchart illustrating the basic steps of this technique. In block 410, we identify a minimum bounding box 300 for the advertisement 120. For simplicity, we assume that the bounding box 300 is a rectangle, but implementations may allow defining bounding boxes 300 of more complex shapes if desired using additional measurement point beyond the two needed for determining a rectangle. The number of necessary measurement points to determine the bounding box depends upon the shape of the bounding box. For example, a triangular bounding box would require identifying the coordinates of three measurement points for each vertex of the triangle.

In block 420, the coordinates of the top left corner 310 and bottom right corner 320 are identified by finding measurement points 150 that are viewable. In some embodiments, the top left corner 310 may be determined by determining which measurement point 150 that is viewable has the minimum X-Y coordinate position, and the bottom right corner 320 may be determined by determining which measurement point 150 that is viewable has the maximum X-Y coordinate position. Once the corners 310, 320 are determined, the bounding box rectangle 300 is therefore also determined. That technique will generate a maximum bounding box, the largest bounding box that will fit within the viewable area of the iframe or the viewport 130. In other embodiments, a minimum bounding box may be determined, finding the rectangle within the iframe with a minimum size that will be sufficient for displaying the advertisement or a reformatted version of the advertisement. Other techniques for determining the corners 310, 320 may be used, including iterative techniques that start with a first size and iteratively shrink the size of the bounding box to achieve a minimum bounding box.

In block 430, the advertisement 120 is compared to the bounding box 300. If the advertisement 120 fits within the rectangle, the advertisement is fully viewable and may be rendered on the user's display screen in the viewport 130 without changes.

If the advertisement 120 does not fit within the bounding box 300, the advertisement 120 may be reformatted to fit within the bounding box 300. In one implementation, the advertisement container of the web page may be resized, transferring the bounding box information to the advertisement itself In another implementation, the bounding box information may be provided directly to the advertisement itself, without requiring access to a parent web page.

In block 440, having determined the bounding box 300 and that the advertisement 120 does not fit into the bounding box 300, the advertisement 120 be resized, so that 100% (or as close to 100% as possible) of the advertisement fits into the bounding box 300. Rules may be employed to determine what percentage of the advertisement 120 is sufficient to fit within the bounding box 300. In addition, rules may be employed that limit the amount of resizing that is acceptable, so that the advertisement 200 is not made illegible by resizing too small. Alternately, although the bounding box 300 and advertisement 120 may continue to define a space that is only partially in the viewport 130, the contents and formatting of the advertisement 120 may be changed, so that the most important portion of the advertisement is visible in the bounding box area. For example an advertisement 120 that is too big for the bounding box 300 may be able to move the content of the advertisement 120 into a condensed space to ensure that the most important features of the advertisement 120, such as the call to action, are visible as an impression. Combinations of resizing and reformatting may be used in some embodiment, for example, shrinking the advertisement 120 by 50% before reformatting the advertisement 120 to rearrange the most important features (now shrunk in size) into the bounding box 300. Such a responsive advertisement format may not need to change the size of the viewport, etc., but could take advantage of the knowledge of the viewport to present the reformatted advertisement.

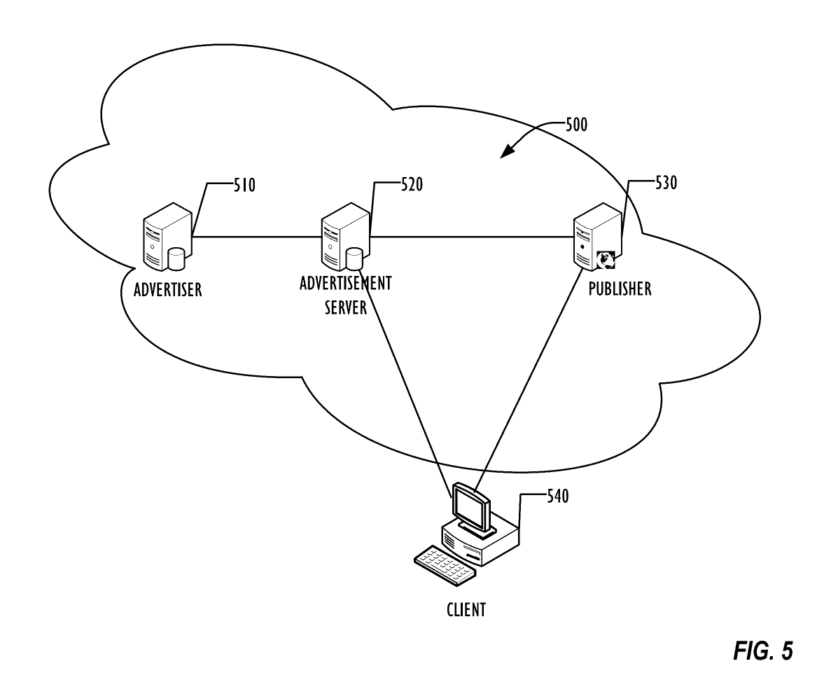

FIG. 5 is a block diagram illustrating a system 500 for the delivery of advertisements to a user according to one embodiment. The system 500 comprises an advertiser 510, an advertisement server 520, a publisher 530, and a client device 540 operated by the user. FIG. 5 also indicates communications channels between these features. These communications may take place over any type of appropriate communications network, including Local Area Networks (LANs), Wide Area Networks (WANs) and so on, but in a typical embodiment each of the the advertiser 510, the advertisement server 520, the publisher 530, and the client device 540 are connected to the Internet, which provides communications between these devices.

The advertiser 510, the advertisement server 520, and the publisher 530 may be implemented using conventional computer server systems. Each of these participants in the system may represent a single computer server or may represent a collection of computer servers as appropriate. The person of ordinary skill will also recognize that various participants may share computer hardware or be hosted on the same machines if convenient.

The client device 540 may be implemented as any network enabled device. For example, the client device 540 may be implemented as a personal computer, laptop computer, tablet computer, smartphone or the like. In typical embodiments, the client device 540 is an Internet enabled device, but the person of ordinary skill will appreciate that alternative methods for delivering content to the client device 540 may be employed.

FIG. 5 omits, for the sake of clarity, other devices that may be involved in the delivery of the advertisement 120. For example, there may be various other servers and communication channels related to the process of bidding on an advertisement that are omitted from FIG. 5. The client 540 may connect to multiple advertisement servers 520 during processing of the web page 100, and scripts and other client-side code used to implement the advertisement reformatting techniques may be obtained from other servers as desired. The techniques described below may be repeated for each advertisement that may be placed onto the web page 100.

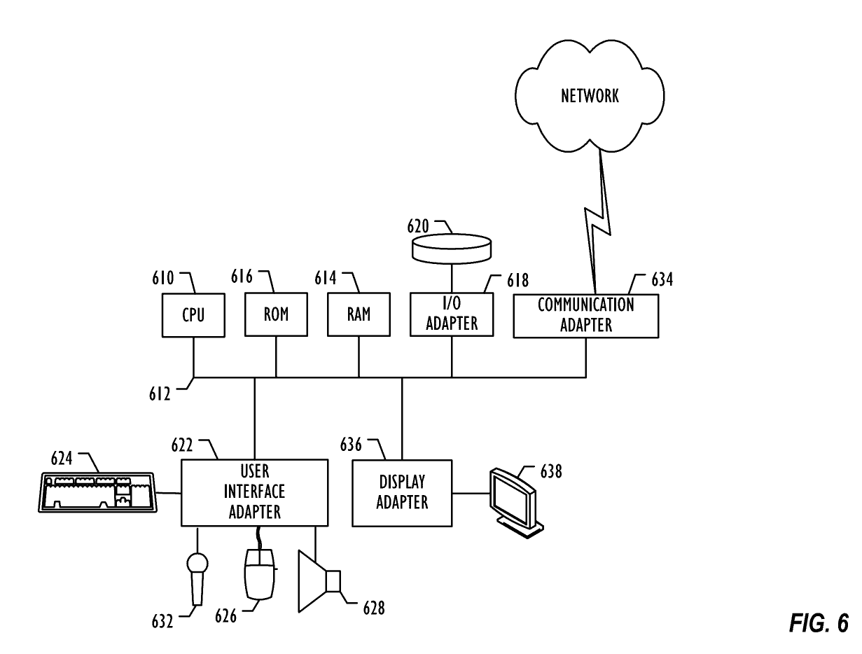

FIG. 6 illustrates a representative hardware environment that may be associated with the servers 510, 520, 530, and/or clients 540 of FIG. 5, in accordance with one embodiment. Such figure illustrates a typical hardware configuration of a workstation in accordance with one embodiment having a central processing unit 510, such as a microprocessor, and a number of other units interconnected via a system bus 512. Although only one of each type of component is shown in FIG. 6, any number of each type component may be implemented as desired. Although illustrated with a bus interconnect, other types of interconnects, including point-to-point interconnects may be used. As illustrated in FIG. 6, the workstation is configured for a typical client device. Servers 510, 520, 530, may be implemented without some of the components typically used for human user interfaces, but may be implemented with those components as desired.

The workstation illustrated in FIG. 6 includes a Random Access Memory (RAM) 614, Read Only Memory (ROM) 616, an I/O adapter 618 for connecting peripheral devices such as disk storage units 620 to the bus 612, a user interface adapter 622 for connecting a keyboard 624, a mouse 626, a speaker 628, a microphone 632, and/or other user interface devices such as a touch screen (not shown) to the bus 612, communication adapter 634 for connecting the workstation to a communication network 635 (e.g., the Internet) and a display adapter 636 for connecting the bus 612 to a display device 638.

The workstation may have resident thereon any desired operating system. An embodiment may also be implemented on platforms and operating systems other than those mentioned. The system architecture of FIG. 6 is illustrative and by way of example only, and other architectures for the workstation and servers may be used, each of which may have a different architecture as desired.

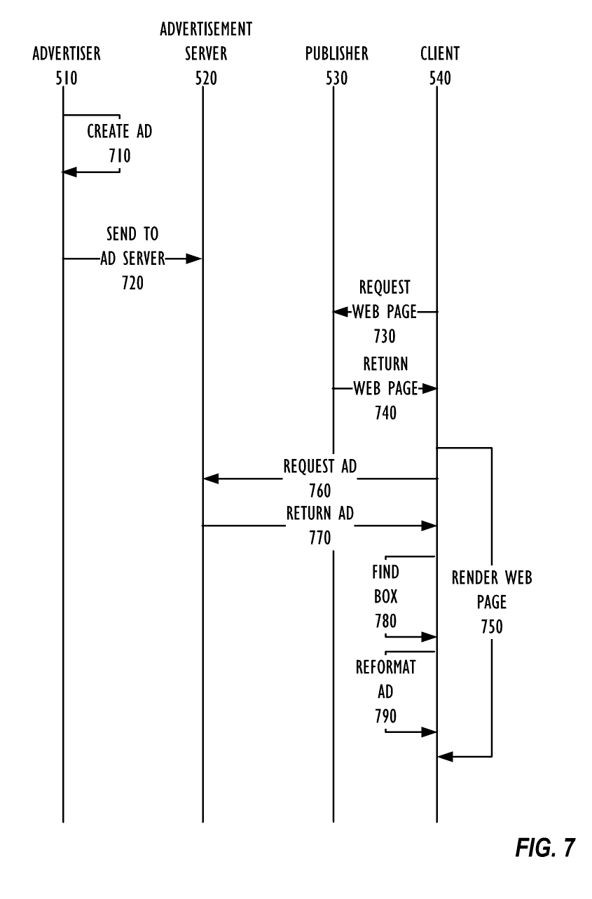

FIG. 7 which shows certain activities of each of the participants illustrated in FIG. 5 during the delivery of a web page 100 to a client device 550. Other actions, including actions related to advertisement bidding, are omitted for clarity. In a typical embodiment, the advertisement is only selected as a result of a bidding process.

At step 710, the advertiser 510 creates the advertisement 120 and sends the advertisement 120 to the advertisement server 520 in step 720. The advertisement 120 may provide information about a product sold by the advertiser 520, for example, and may include elements such as text, images, moving images, sound, or a combination of these. The advertisement 120 may also include one or more hyperlinks, so that when the advertisement 120 is rendered by the client device 540, the user may select these hyperlinks in order to be redirected to further content provided by the advertiser 510. The advertisement may be encoded by the advertiser 510 as a HyperText Mark-up Language (HTML) file. In addition, the advertisement 120 may contain client-side code to perform the bounding box detection and advertisement reformatting. The client-side code is typically written in a scripting language such as JAVASCRIPT® (JAVASCRIPT is a registered trademark of Oracle America, Inc.), but the client code may be written in any form desired. The client side code may download additional client side code from the advertising server or elsewhere, which when downloaded is executed to perform the bounding box detection and advertisement reformatting.

The client-side code is incorporated into the advertisement 120, typically by either the advertiser 510 or the advertisement server 520. The advertiser 510 can be understood as an organization or entity that wishes to promote a product or a service, while the advertisement server 520 is operated by an organization which offers to find advertising space for the advertiser 510. Which advertisement is served by the advertisement server 520 is generally not determined until a request for an advertisement is received. Upon receipt of the request, a bidding procedure is used to determine which advertisement is to be served by the advertisement server. The nature of the bidding procedure is outside the scope of this disclosure and is not further described herein. The advertisement server 520 has relationships with multiple advertisers 510 and multiple publishers 530, and acts as an intermediary to assist in the placement of advertisements with suitable publishers.

The advertisement server 520 has a relationship with the publisher 530 by which advertisements are provided in the publisher's content. The publisher 530 incorporates links to the advertisement server 520 in web pages the publisher 530 provides to users. These links are delivered within iframes, isolating content delivered in the iframe from affecting the web page 100, ensuring that the advertisements provided by the advertisement server 520 will not adversely affect the content the publisher 530 is publishing in the host web page. The publisher 530 typically has little or no control over or knowledge of the advertisement served via the publisher 530′s web pages.

When client device 540 request a web page 100 from the publisher 530 in step 730, the publisher returns the web page 100 to the client device 540 at step 740. The client device then begins to render this web page at step 750. The rendering process is typically undertaken by a browser operating on the client device 540.

The iframe containing the advertisement 120 is linked to an address at the advertisement server 520. When the browser operating at the client device 540 attempts to render the web page 100, the browser is instructed by the iframe to request further information from the advertisement server 520 to populate the iframe. This request is transmitted from the client device 540 to the advertisement server 520 at step 760.

On receiving the request, the advertisement server 520 selects what advertisement to provide to the client device 540, typically based on an online bidding procedure that is well known in the industry. The advertisement server 530 in step 770 returns the selected advertisement 120 provided by the advertiser 510. Where a web page contains multiple locations for advertisements, this request/response procedure may be repeated multiple times and depending on the capabilities of the browser, may be performed sequentially, in parallel, or a mixture of sequential and parallel.

As mentioned above, the advertisement 120 contains the client side code. The client side code is executed by the client device 540 at step 780 as part of the process of rendering the web page 100. When the client side code is executed by the client device 540, in step 780 the bounding box 300 for the advertisement is determined as described above. Once the bounding box 300 is determined, in step 790 the client side code may cause the advertisement 120 to be resized, reformatted, both, improving the display of the advertisement 120 in the bounding box 300.

In some embodiments, the reformatting or resizing of the advertisement 120 is performed at least in part by the client code requesting a different form of the advertisement 120 from the advertising server 520. For example, if the original advertisement 120 was designed to fit into a 500×500 pixel space and the bounding box is a 300×300 pixel space, the client code may request a version of the advertisement 120 that fits into the 300×300 pixel space. Advertisement servers 520 often maintain multiple sizes of an advertisement.

Alternately, the client side code may contain instructions that when executed cause the client side code to generate the resized advertisement 120 from the original advertisement 120, using any desired resizing technique.

Similarly, reformatting may be performed by requesting a different format of the advertisement 120 from the advertisement server 520 or by reformatting the original advertisement 120 on the client 540. Reformatting may involve rearranging element in the advertisement 120 so that important elements, such as the call to action, fit into a space the size and shape of the bounding box 300, so that even if a less important portion of the advertisement 120 is not viewable, the more important portion is. Any desired technique for automatically reformatting an advertisement to fit in a specific size space may be used.

In some embodiments, the client side code may request a different advertisement 120 from the advertisement server 520 if resizing or reformatting of the original advertisement 120 is impossible or impractical. In such a situation, a new bidding procedure may be invoked to select the replacement advertisement.

Because of the nature of online advertising, all of the resizing and reformatting is performed automatically, without human intervention.

Eventually, all of the advertisements 120 that need resizing or reformatting are resized or reformatted and the web page rendering of step 750 completes, displaying the web page with the advertisement 120 to the user.

In some embodiments, the measurement points that are used to determine the size and location of the visible bounding box are generated and embedded by the client side code. In other embodiments, the measurement points may be served as part of the advertisement 120 either as code embedded in the advertisement or as part of the creative itself.

In some embodiments, the client side code may be an applet and may obtain information for the purpose of determining the bounding box 300 directly or indirectly via an external or internal browser application programming interface (API),

Embodiments, as described herein, may include, or may operate on, logic or a number of components, modules, or mechanisms. Modules may be hardware, software, or firmware communicatively coupled to one or more processing elements in order to carry out the operations described herein. Modules may be hardware modules, and as such, modules may be considered tangible entities capable of performing specified operations and may be configured or arranged in a certain manner. Circuits may be arranged (e.g., internally or with respect to external entities such as other circuits) in a specified manner as a module. The whole or part of one or more programmable devices (e.g., a standalone client or server computer system) or one or more hardware processing elements may be configured by firmware or software (e.g., instructions, an application portion, or an application) as a module that operates to perform specified operations. The software may reside on a computer readable medium. The software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Where modules are temporarily configured, each of the modules need not be instantiated at any one moment in time. For example, where the modules comprise a general-purpose hardware processing element configured using software; the general-purpose hardware processing element may be configured as respective different modules at different times. Software may accordingly program a hardware processor, for example, to constitute a particular module at one instance of time and to constitute a different module at a different instance of time. Modules may also be software or firmware modules, which operate to perform the methodologies described herein.

While certain embodiments have been described in details and shown in the accompanying drawings, it is to be understood that such embodiments are merely illustrative of and not devised without departing from the basic scope thereof, which is determined by the claims that follow.

We claim:

1. A method of presenting an advertisement on a web page in a viewable area, comprising:
determining, by a client programmable device, a viewable bounding area available for use by the advertisement; and
reformatting the advertisement responsive to the bounding area.

2. The method of claim 1, where reformatting the advertisement comprises resizing the advertisement.

3. The method of claim 1, wherein determining a bounding area comprises:
selecting a plurality of measurement points;
determining the viewability of each of the measurement points;
defining the viewable bounding area as the upper left corner and bottom right corner of a rectangle defined by viewable measurement points.

4. The method of claim 3, wherein the plurality of measurement points comprise single pixel transparent media.

5. The method of claim 3, wherein at least two of the plurality of measurement points are viewable.

6. The method of claim 1, wherein reformatting the advertisement comprises reformatting the advertisement to ensure a call to action is rendered in the bounding area.

7. The method of claim 1, wherein the bounding area is a rectangle.

8. A non-transitory machine readable medium storing software for reformatting an advertisement based on viewability, comprising instructions that when executed cause a programmable device to:
determine a viewable bounding area available for use by the advertisement; and
reformat the advertisement responsive to the bounding area.

9. The machine readable medium of claim 8, wherein the instructions that when executed cause the programmable device to reformat the advertisement comprise instructions that when executed cause the programmable device to resize the advertisement.

10. The machine readable medium of claim 8, wherein the instructions that when executed cause the programmable device to determine a bounding area comprise instructions that when executed cause the programmable device to:
select a plurality of measurement points;
determine the viewability of each of the measurement points;
define the viewable bounding area as the upper left corner and bottom right corner of a rectangle defined by viewable measurement points.

11. The machine readable medium of claim 10, wherein the plurality of measurement points comprise single pixel transparent media.

12. The machine readable medium of claim 10, wherein at least two of the plurality of measurement points are viewable.

13. The machine readable medium of claim 8, wherein the instructions that when executed cause the programmable device to reformat the advertisement comprise instructions that when executed cause the programmable device to rearrange elements of the advertisement to ensure a call to action is rendered in the bounding area.

14. The machine readable medium of claim 8, wherein the bounding area is a rectangle.

15. An advertising server configured to deliver responsive advertisements, comprising:
a processing element;
a memory, storing software for delivering advertisements to a client device, comprising instructions that when executed cause the processing element to:
select an advertisement responsive to a request from the client device;
deliver the advertisement to the client device, wherein the advertisement includes code for execution by the client device, comprising instructions that when executed cause the client device to:
determine a viewable bounding area available for use by the advertisement; and
reformat the advertisement responsive to the bounding area.

16. The advertising server of claim 15, wherein the instructions that when executed cause the programmable device to reformat the advertisement comprise instructions that when executed cause the programmable device to resize the advertisement.

17. The advertising server of claim 8, wherein the instructions that when executed cause the client device to determine a bounding area comprise instructions that when executed cause the client device to:
select a plurality of measurement points;
determine the viewability of each of the measurement points;
define the viewable bounding area as the upper left corner and bottom right corner of a rectangle defined by viewable measurement points.

18. The advertising server of claim 17, wherein the plurality of measurement points comprise single pixel transparent media.

19. The advertising server of claim 17, wherein at least two of the plurality of measurement points are viewable.

20. The advertising server of claim 8, wherein the instructions that when executed cause the client device to reformat the advertisement comprise instructions that when executed cause the client device to rearrange elements of the advertisement to ensure a call to action is rendered in the bounding area.
